(19) United States
(12) Patent Application Publication
(10) Pub. No.: US 2015/0022879 A1
(43) Pub. Date: Jan. 22, 2015

(54) INFRARED REFLECTIVE FILM

(71) Applicant: NITTO DENKO CORPORATION, Ibaraki-shi, Osaka (JP)

(72) Inventors: Motoko Kawasaki, Ibaraki-shi (JP); Junichi Fujisawa, Ibaraki-shi (JP); Yutaka Ohmori, Ibaraki-shi (JP); Tomonori Hyodo, Ibaraki-shi (JP)

(21) Appl. No.: 14/375,228

(22) PCT Filed: Jan. 30, 2013
(86) PCT No.: PCT/JP2013/052015

§ 371 Date: Jul. 29, 2014

(30) Foreign Application Priority Data
Jan. 30, 2012 (JP) 2012-017189
Jun. 11, 2012 (JP) 2012-132284

(51) Int. Cl. G02B 5/20; G02B 5/26

(52) U.S. Cl. CPC G02B 5/208; G02B 5/26
USPC 359/359

(57) ABSTRACT

Provided is an infrared reflective film in which a reflective layer and a protective layer are sequentially layered on one surface of a substrate. The protective layer contains a polymer, and the dynamic friction coefficient on the surface of the protective layer is 0.001 to 0.45.

### FIELD

The present invention relates to an infrared reflective film having high transmittance in a visible light region and having high reflectivity in an infrared light region.

### BACKGROUND

Infrared reflective films are mainly used for suppressing thermal effects of sunlight radiation. For example, by attaching an infrared reflective film to a window glass of buildings, motor vehicles, etc., it is possible to block infrared radiation (particularly near infrared radiation) entering the indoor passing through the window glass so as to suppress an increase in the indoor temperature, which can enhance energy saving by suppressing the consumption power for cooling.

For reflecting infrared radiation, an infrared reflective layer having a layer structure of metal or metal oxide is used. However, metal or metal oxide has a low abrasion resistance. Therefore, a protective layer is generally provided on an infrared reflective layer in infrared reflective films. For example, Patent Literature 1 discloses use of polyacrylonitrile (PAN) as a material for a protective layer. Polymers such as polyacrylonitrile having a low absorbance of infrared radiation can block far infrared radiation outgoing from the indoor passing through a translucent member, which therefore can enhance energy saving due to a heat insulating effect during winter or night when the outdoor temperature decreases.

In the case of using such a polymer as polyacrylonitrile as a material for a protective layer, the protective layer is formed by the procedure in which a solution is first prepared by dissolving the polymer in a solvent, and the thus obtained solution is applied onto an infrared reflective layer, followed by drying of the solution (the solvent is volatilized).

### CITATION LIST

### Patent Literature

Patent Literature 1: JP 61 (1986)-051762 B

### SUMMARY

### Technical Problem

Meanwhile, it is known that polyacrylonitrile is soluble only in solvents having a high boiling point such as dimethylformamide (DMF) (boiling point: 153° C.). When a solvent has a high boiling point, it is possible to reduce the time required for a drying step by increasing the temperature of the drying step, whereas there is a possibility that a substrate is damaged due to high temperature in the case of the substrate made of a polymer material. Therefore, there is a need to perform a drying step at a temperature that does not damage a substrate, thereby requiring a long duration of the drying step in the case of using polyacrylonitrile as a material for a protective layer, which is a problem. In order to solve this problem, the inventors have come up with an idea of using a copolymer of acrylonitrile, which is soluble in a solvent having a low boiling point such as methyl ethyl ketone (MEK) (boiling point: 80° C.), and another monomer component, for a protective layer.

However, the inventors faced a problem that the copolymer of acrylonitrile and another monomer component cannot impart sufficient surface slip characteristics (slip properties) to the protective layer. It is inferred that, since an infrared reflective film using polyacrylonitrile for a protective layer has sufficient slip characteristics, the problem of slip characteristics is caused by the other monomer component. Poor surface slip characteristics of a protective layer causes a problem that an excessive force (stress) acts on the surface of the protective layer, for example, when cleaning a window of buildings or motor vehicles to which an infrared reflective film is attached, and the protective layer is partially or entirely damaged, resulting in exposure of an infrared reflective layer having low abrasion resistance.

Therefore, the present invention has been devised in view of such circumstances, and an object thereof is to provide an infrared reflective film having excellent slip characteristics (slip properties).

### Solution to Problem

An infrared reflective film includes a reflective layer and a protective layer, which are sequentially layered on one surface of a substrate, wherein the protective layer contains a polymer containing at least two repeating units of repeating units A, B, and C shown in Formula I below:

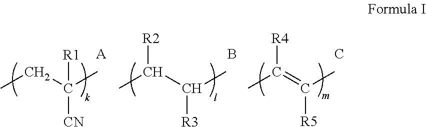

(R1: H or a methyl group, R2 to R5: H, or an alkyl group or an alkenyl group having 1 to 4 carbon atoms), and

a dynamic friction coefficient of a surface of the protective layer is 0.001 to 0.45.

According to one aspect of the present invention, the infrared reflective film may have a normal emissivity on the surface on the protective layer side of 0.20 or less.

Further, according to one aspect of the present invention, the infrared reflective film may be configured so that the protective layer further contains a silicone component which forms a surface of the protective layer in an amount of 0.0001 to 1.0000 g/m².

### Advantageous Effects of Invention

The present invention can provide an infrared reflective film having excellent slip characteristics (slip properties).

### BRIEF DESCRIPTION OF DRAWINGS

FIG. 1 is a schematic view illustrating a layer structure of an infrared reflective film according to an embodiment of the present invention.

FIG. 2 is a view of a basic configuration of testing parts of a ball-on-disk friction and wear tester for determining a dynamic friction coefficient of an infrared reflective film according to an embodiment of the present invention.

### DESCRIPTION OF EMBODIMENTS

Hereinafter, an infrared reflective film according to an embodiment of the present invention is described. The infrared reflective film according to this embodiment has heat insulating properties (reflective properties for far infrared radiation), in addition to thermal barrier properties (reflective properties for near infrared radiation) of conventional infrared reflective films.

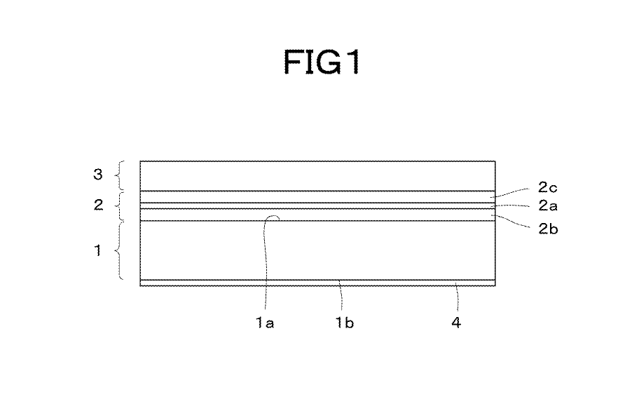

As shown in FIG. 1, the infrared reflective film according to this embodiment has a layer structure in which a reflective layer 2 and a protective layer 3 are layered in this order on one surface 1a of a substrate 1, and an adhesive layer 4 is provided on the other surface 1b thereof.

A polyester film is used for the substrate 1, and examples thereof include films made of polyethylene terephthalate, polyethylene naphthalate, polypropylene terephthalate, polybutylene terephthalate, polycyclohexylenemethylene terephthalate, and a mixed resin of two or more of these. Among these, a polyethylene terephthalate (PET) film is preferable, and a biaxially stretched polyethylene terephthalate (PET) film is particularly suitable, from the viewpoint of performance.

The reflective layer 2 is a deposition layer that is formed on the surface (one surface) 1a of the substrate 1 by vapor deposition. Examples of a method for forming a deposition layer include physical vapor deposition (PVD) such as sputtering, vacuum vapor deposition, and ion plating. In vacuum vapor deposition, a deposition material is heated and evaporated under vacuum by a method such as resistance heating, electron beam heating, laser beam heating, and arc discharge. Thus, the reflective layer 2 is formed on the substrate 1. In sputtering, cations such as Ar+ accelerated, for example, by glow discharge are allowed to collide with a target (deposition material) so that the deposition material is sputtered and evaporated under vacuum in the presence of an inert gas such as argon. Thus, the reflective layer 2 is formed on the substrate 1. Ion plating is a vapor deposition method combining vacuum vapor deposition and sputtering. In this method, evaporated atoms released by heating are ionized and accelerated in an electric field so as to attach onto the substrate 1 in a high energy state under vacuum. Thus, the reflective layer 2 is formed.

The reflective layer 2 has a multilayer structure in which a semi-transparent metal layer 2a is sandwiched by a pair of metal oxide layers 2b and 2c. The reflective layer 2 is formed by first depositing a metal oxide layer 2b on the surface (one surface) 1a of the substrate 1, then depositing the semi-transparent metal layer 2a on the metal oxide layer 2b, and finally depositing a metal oxide layer 2c on the semi-transparent metal layer 2a, using the aforementioned method for forming a deposition layer. For the semi-transparent metal layer 2a, a metal material such as aluminum (Al), silver (Ag), silver alloy (MgAg, Ag—Pd—Cu alloy (APC), AgCu, AgAuCu, AgPd, AgAu, etc.), and aluminum alloy (AlLi, AlCa, AlMg, etc.), or a metal material obtained by combining two or more types or two or more layers of these, for example, is used. The metal oxide layers 2b and 2c impart transparency to the reflective layer 2, and serves to prevent the deterioration of the semi-transparent metal layer 2a. For example, an oxide such as indium tin oxide (ITO), indium titanium oxide (IT), indium zinc oxide (IZO), gallium zinc oxide (GZO), aluminum zinc oxide (AZO), and indium gallium oxide (IGO) is used therefor.

The protective layer 3 contains a polymer containing at least two repeating units of the repeating units A, B, and C in Formula I below. H or a methyl group can be used as R1 in Formula I. Further, H, or an alkyl group or an alkenyl group having 1 to 4 carbon atoms can be used as R2 to R5 in Formula I. Incidentally, a material that is composed of the repeating units A, B, and C, and uses H as R1 to R5 is hydrogenated nitrile rubber (HNBR).

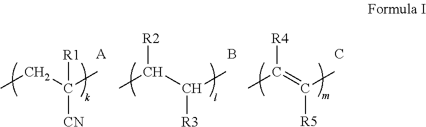

(R1: H or a methyl group, R2 to R5: H, or an alkyl group or an alkenyl group having 1 to 4 carbon atoms)

Examples of monomer components for obtaining such a polymer include acrylonitrile (repeating unit D) and its derivatives, alkyl (repeating unit E) having 4 carbon atoms and its derivatives, butadiene (repeating unit F1 or F2), and copolymers of those derivatives, as shown in Formula II. Here, R6 denotes H or a methyl group, and R7 to R18 each denote H or an alkyl group having 1 to 4 carbon atoms. F1 and F2 each denote a repeating unit in which butadiene is polymerized, and F1 is a main repeating unit. Further, the polymer may be nitrile rubber that is a copolymer of acrylonitrile (repeating unit D) and its derivatives, and 1,3-butadiene (repeating unit F1) and its derivatives, which are shown in Formula II, or hydrogenated nitrile rubber obtained by partially or entirely hydrogenating the double bond contained in nitrile rubber.

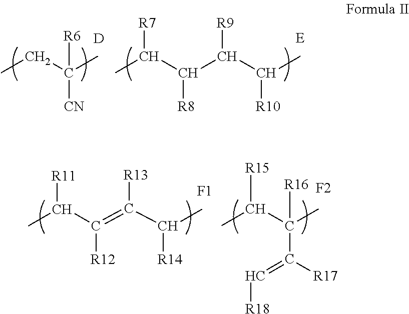

(R6: H or a methyl group, R7 to R18: H, or an alkyl group having 1 to 4 carbon atoms)

With reference to Formula III as a cut part of the aforementioned copolymer, a relationship between a copolymer in which acrylonitrile, butadiene, and alkyl are polymerized, and their respective repeating units A, B, and C is described. Formula III is a cut part of a polymer chain used for the protective layer 3, in which 1,3-butadiene (repeating unit F1), acrylonitrile (repeating unit D), and 1,3-butadiene (repeating unit F1) are sequentially bonded. Formula III shows a bonding example in which R7, and R11 to R14 denote H. In Formula III, a side to which a cyano group (-CN) of acrylonitrile is bonded is bonded to butadiene on the left, and butadiene on the right is formed on a side to which a cyano group (-CN) of acrylonitrile is not bonded. In such a bonding example, one repeating unit A, one repeating unit B, and two repeating units C are contained. Among these, the repeating unit A contains a carbon atom to which a carbon atom on the right of butadiene on the left and a cyano group (-CN) of acrylonitrile are bonded, and the repeating unit B has a combination containing a carbon atom to which a cyano group (-CN) of acrylonitrile is not bonded and a carbon atom on the left of butadiene on the right. The carbon atom on the leftmost of butadiene on the left and the carbon atom on the rightmost of butadiene on the right serve as carbon atoms as part of a repeating unit A or a repeating unit B depending on the kind of molecules to which they are bonded.

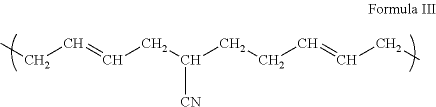

The protective layer 3 is formed by the procedure in which a solution is prepared by dissolving the aforementioned polymer (together with a crosslinking agent, as needed) in a solvent, and the thus obtained solution is applied onto the reflective layer 2, followed by drying of the solution (solvent is volatilized). The solvent is a solvent in which the aforementioned polymer is soluble. Examples thereof include solvents such as methyl ethyl ketone (MEK) and methylene chloride (dichloromethane). It should be noted that methyl ethyl ketone and methylene chloride are solvents having a low boiling point (methyl ethyl ketone has a boiling point of 79.5° C., and methylene chloride has a boiling point of 40° C.). Accordingly, when these solvents are used, the solvents can volatilize at a low drying temperature, and therefore the substrate 1 (or the reflective layer 2) is prevented from being thermally damaged.

The lower limit of the thickness of the protective layer 3 is 1 μm or more. Preferably, it is 3 μm or more. Further, the upper limit thereof is 20 μm or less. Preferably, it is 15 μm or less. More preferably, it is 10 μm or less. When the protective layer 3 has a small thickness, the abrasion resistance is impaired, whereas the reflective properties for infrared radiation are increased. As a result, functions as the protective layer 3 cannot be sufficiently exerted. When the protective layer 3 has a large thickness, the heat insulating properties of the infrared reflective film are deteriorated. When the protective layer 3 has a thickness within the aforementioned range, the protective layer 3 having low absorption of infrared radiation and being capable of suitably protecting the reflective layer 2 is obtained.

A normal emissivity is expressed as Normal emissivity (εn)=1−Spectral reflectivity (ρn), as prescribed in JIS R3106. The spectral reflectivity ρn is measured in the wavelength range 5 to 50 μm of thermal radiation at room temperature. The wavelength range 5 to 50 μm is in the far infrared radiation region. The higher the reflectance in the wavelength range of far infrared radiation, the lower the normal emissivity.

Further, the ratio of k, l, and m in Formula I is preferably k:l:m=5 to 50 wt %:25 to 85 wt %:0 to 60 wt % (however, the total of k, l, and m accounts for 100 wt %). More preferably, the ratio is k:l:m=15 to 40 wt %:55 to 85 wt %:0 to 20 wt % (however, the total of k, l, and m accounts for 100 wt %). Further preferably, the ratio is k:l:m=25 to 40 wt %:55 to 75 wt %:0 to 10 wt % (however, the total of k, l, and m accounts for 100 wt %).

In order to impart good solvent resistance to the protective layer 3, it is preferable that the protective layer 3 have a cross-linked structure of a polymer. When a polymer is cross-linked, the solvent resistance of the protective layer 3 is improved, and therefore it is possible to prevent elution of the protective layer 3 even if the polymer-soluble solvent is in contact with the protective layer 3.

As a technique to allow a polymer to have a cross-linked structure, electron beam irradiation after drying a solution can be mentioned. The lower limit of the accumulated irradiation dose of electron beam is 50 kGy or more. Preferably, it is 100 kGy or more. More preferably, it is 200 kGy or more. Further, the upper limit thereof is 1000 kGy or less. Preferably, it is 600 kGy or less. More preferably, it is 400 kGy or less. It should be noted that the accumulated irradiation dose herein means an irradiation dose in the case where electron beam irradiation is performed one time, or means a total of irradiation doses in the case where electron beam irradiation is performed multiple times. It is preferable that the dose of one-time electron beam irradiation be 300 kGy or less. When the accumulated irradiation dose of electron beam falls within the aforementioned range, a polymer can be sufficiently cross-linked. Further, when the accumulated irradiation dose of electron beam irradiation falls within the aforementioned range, it is possible to suppress yellowing of a polymer or the substrate 1 caused by electron beam irradiation to the minimum, so that an infrared reflective film having less coloration can be obtained. Such electron beam irradiation is performed under conditions using an acceleration voltage of 150 kV.

Further, when a polymer is dissolved in a solvent, or after a polymer is dissolved in a solvent, a crosslinking agent such as a polyfunctional monomer, such as a radically polymerizable monomer is preferably added thereto. Particularly, a radically polymerizable monomer of a (meth)acrylate monomer is preferable. Addition of such a polyfunctional monomer allows functional groups contained in the polyfunctional monomer to react (bond) with the respective polymer chains, thereby facilitating the cross-linking of a polymer (via the polyfunctional monomer). Accordingly, even when the accumulated irradiation dose of electron beam is reduced (to about 50 kGy), a polymer can be sufficiently cross-linked. Therefore, the accumulated irradiation dose of electron beam can be reduced to a low level. Further, such a reduction in accumulated irradiation dose of electron beam can further suppress yellowing of a polymer or the substrate 1, and can improve the productivity.

However, when the amount of additive increases, the normal emissivity of the surface of the infrared reflective film on the protective layer 3 side (with respect to the reflective layer 2) is deteriorated. When the normal emissivity is deteriorated, the infrared reflective properties of the infrared reflective film are reduced, and the heat insulating properties of the infrared reflective film are degraded. Therefore, the amount of additive is preferably 1 to 35 wt % with respect to the polymer. More preferably, it is 2 to 25 wt % with respect to the polymer.

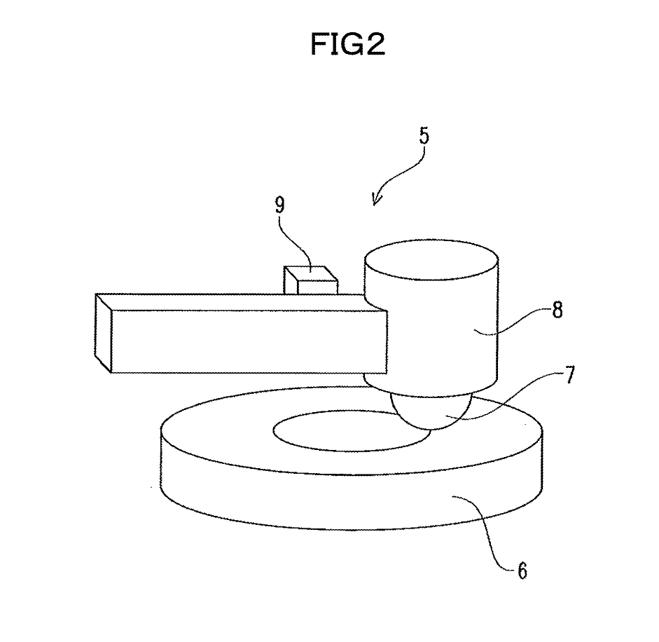

The dynamic friction coefficient on the surface of the protective layer 3 is 0.001 to 0.45. The dynamic friction coefficient can be measured, for example, using a ball-on-disk friction and wear tester 5. More specifically, as shown in FIG. 2, the ball-on-disk friction and wear tester 5 has a configuration in which a fixed ball 7 is arranged on a sample disk 6, and a load of a weight 8 is applied thereon from above the fixed ball 7. With such a state, a friction force caused by a rotation of the sample disk 6 is measured by a sensor 9, and the measured value of the friction force is divided by the load applied from above the fixed ball 7. Thus, the coefficient of friction is calculated. When the dynamic friction coefficient on the surface of the protective layer 3 is within the aforementioned range, good slip characteristics (slip properties) can be imparted to the surface of the protective layer 3.

For adjusting the dynamic friction coefficient on the surface of the protective layer 3 to the aforementioned range, there is a method in which a polymer solution obtained by dissolving a polymer containing acrylonitrile and butadiene as its constituent unit and a leveling agent in a solution is prepared, and the polymer solution is applied onto the reflective layer 2, followed by drying, so that the protective layer 3 is obtained, for example. The leveling agent that is added to the polymer containing acrylonitrile and butadiene as its constituent unit is used for the purpose of improving slip characteristics (slip properties) of the surface of the protective layer 3. As such a leveling agent, a silicone leveling agent is preferably used.

The lower limit of the content of the leveling agent in the polymer with respect to the polymer as a whole is 0.1 wt % or more. Preferably, it is 0.2 wt % or more. More preferably, it is 0.5 wt % or more. Further, the upper limit thereof is 5 wt % or less. Preferably, it is 2 wt % or less. More preferably, it is 1 wt % or less.

For adjusting the dynamic friction coefficient on the surface of the protective layer 3 to the aforementioned range, there is another method in which a substrate (release liner) with a silicone component formed thereon is laminated onto a protective layer (layer composed of the aforementioned polymer) subjected to electron beam irradiation, so that the silicone component is transferred to the surface of the protective layer 3, for example. In this method, it is preferable to use the protective layer 3 formed by using such a polymer solution containing a leveling agent as mentioned above. When the polymer solution containing a leveling agent is used, radicals which are derived from the leveling agent and are present on the surface of the protective layer 3 are bonded to the silicone component by electron beam irradiation. Therefore, as compared to the case of using a polymer solution free from a leveling agent, the silicone component is better transferred onto the protective layer 3. Therefore, the dynamic friction coefficient on the surface of the protective layer 3 can be more reduced. Before the lamination, the protective layer may be subjected to electron beam irradiation or may be not subjected to electron beam irradiation. However, when the substrate with a silicone component formed thereon is subjected to electron beam irradiation in the state of being laminated to the protective layer, the polymer which is contained in the protective layer and is activated by the electron beam is bonded to the component contained in the substrate, thereby making it difficult to peel off the substrate.

The silicone component in the present invention is a polymer in which a methyl group or a methoxy group is bonded to silicon atoms of a siloxane backbone in which the silicon atoms and oxygen atoms are alternately bonded in a molecule (where the number of repeating units of silicon atoms and oxygen atoms is generally about 10 to 8000). The aforementioned methyl group may be a compound that is partially substituted with an organic functional group such as a phenyl group, a vinyl group, and an amino group. The aforementioned polymer may contain a polymerizable functional group such as a silanol group (—Si—OH), an alkenyl group, an epoxy group, and a (meth)acryloyl group at its ends or side chains. The number of polymerizable functional groups to be contained in the polymer is not specifically limited. The polymer may contain polymerizable functional groups at both ends, and may contain, in the case of being a branched polymer, polymerizable functional groups at both ends and all the side chains. Further, as long as the coefficient of friction of the protective layer is sufficiently reduced, the number of repetitions of silicon atoms and oxygen atoms is not limited to the aforementioned values.

Transparent resin substrates (release liners) with a silicone component formed thereon are classified into a heat curable type and an active energy ray curable type. The heat curable type is further classified into a condensation reaction type and an addition reaction type. The active energy ray curable type is further classified into an ultraviolet curable type (including a radical polymerization type and a cationic polymerization type) and an electron beam curable type.

In the case of a transparent resin substrate with a silicone component of the condensation reaction type of the heat curable type formed thereon, a cross-linked product obtained, for example, by subjecting a base polymer having silanol groups (—Si—OH) at both ends of a siloxane molecule, and a crosslinking agent in which a methyl group of polymethylhydrosiloxane or polymethylhydrosiloxane that has hydrogen atoms is partially modified into a methoxy group, to dehydrogenation or dealcoholization with an organic tin catalyst is used for silicone treatment. To the aforementioned cross-linked product, a silicone polymer having a molecular weight that is lower than that of the base polymer may be separately added, in order to adjust the peel force from the release liner. Among these, unreacted components of the base polymer, the crosslinking agent, and components of the silicone polymer having a low molecular weight in the aforementioned reaction are inferred to contribute to a reduction of the dynamic friction coefficient.

In the case of a transparent resin substrate with a silicone component of the addition reaction type of the heat curable type formed thereon, a cross-linked product obtained, for example, by subjecting a base polymer having alkenyl groups such as vinyl groups at both ends of a siloxane molecule, or at both ends and side chains thereof, and polymethylhydrosiloxane having hydrogen atoms, to hydrosilylation (addition reaction) with a platinum catalyst is used. To the aforementioned cross-linked product, a silicone polymer having a molecular weight that is lower than that of the base polymer may be separately added, in order to adjust the peel force from the release liner. Among these, unreacted components of the base polymer, the crosslinking agent, and components of the silicone polymer having a low molecular weight in the aforementioned reaction are inferred to contribute to a reduction of the dynamic friction coefficient.

Further, also in the case of a transparent resin substrate with a silicone component of the active energy ray curable type formed thereon, unreacted components of the respective materials are inferred to contribute to a reduction of the dynamic friction coefficient on the surface of the protective layer, in the same manner as in the aforementioned cases. The transparent resin substrate with a silicone component formed on a surface on the opposite side of the adhesive layer is preferably a transparent resin substrate with a silicone component of the condensation reaction type of the heat curable type formed thereon, because of its tendency to have a larger amount of unreacted components that contribute to a reduction of the dynamic friction coefficient, as compared to other reaction types.

Although there is no specific limitation, polyethylene terephthalate is typically used as a material for the transparent resin substrate. As a transparent resin substrate with a silicone component formed on its surface, a commercially available polyester release film subjected to silicone treatment, such as “MRE” Series and “MRN” Series of “DIAFOIL” (product name), manufactured by Mitsubishi Plastics, Inc., can be used. A film coated with silicone of the condensation type of the heat curable type is employed as a transparent resin substrate (release liner) in Examples 1 to 3, and a film coated with silicone of the addition type of the heat curable type is employed as a transparent resin substrate (release liner) in Examples 4 to 5. However, the transparent resin substrate (release liner) is not limited thereto.

After the transfer, the amount of silicone component forming the surface of the protective layer 3 (transferred amount of silicone) is in the range of 0.0001 g/m² to 1.0000 g/m². It is preferably 0.0002 g/m² to 0.5000 g/m², more preferably 0.0004 g/m² to 0.3000 g/m², further preferably 0.0005 g/m² to 0.1000 g/m². When the transferred amount of silicone is 0.0001 g/m² or less, there is a possibility of failure to impart good slip characteristics to the protective layer 3. When it exceeds 1.0000 g/m², there is a possibility of surface whitening.

On the other hand, when the transferred amount of silicone falls within the aforementioned range, good slip characteristics (slip properties) can be imparted to the infrared reflective film. It should be noted that the transferred amount of silicone is an amount of silicone component that is present on the surface of the protective layer 3 after the substrate used for the transfer is peeled off so that the silicone component is exposed.

The transferred amount of silicone can be measured, for example, by using a fluorescent X-ray diffractometer. More specifically, a silicone component layer on the surface of the protective layer 3 is subjected to a measurement using fluorescent X-ray diffraction (XRF), as described in the examples below, so that a Si—Ka curve is obtained. The intensity of Si is determined from the obtained Si—Ka curve, and the intensity of Si is expressed in terms of an amount of Si. Further, the amount of Si is expressed in terms of a transferred amount of silicone (amount of compound). Thus, the transferred amount of silicone can be measured.

According to this embodiment configured as above, the normal emissivity on the surface on the protective layer 3 side (with reference to the reflective layer 2) of the infrared reflective film is reduced by reducing the thickness of the layer structure on the reflective layer 2, that is, the thickness of the protective layer 3. The normal emissivity is further reduced also by using nitrile rubber, hydrogenated nitrile rubber, completely hydrogenated nitrile rubber, or the like, which are particularly less likely to absorb far infrared radiation, but likely to transmit far infrared radiation as the protective layer 3. This makes it difficult for the protective layer 3 to absorb far infrared radiation even if it is incident on the protective layer 3, so that far infrared radiation reaches the reflective layer 2. As a result, far infrared radiation is more likely to be reflected by the reflective layer 2. Accordingly, it is possible to block far infrared radiation outgoing from the indoor to the outside passing through a translucent member such as a window glass by attaching the infrared reflective film according to this embodiment to the translucent member from the indoor side, which allows a heat insulating effect to be expected, during winter or night when the indoor temperature decreases. For this purpose, the normal emissivity on the surface of the protective layer 3 side of the infrared reflective film according to this embodiment is set to 0.20 or less. More preferably, the normal emissivity is 0.15 or less.

Further, in the infrared reflective film of this embodiment, the translucency of the translucent member is not inhibited by increasing the visible light transmission (see JIS A5759). For this purpose, the visible light transmission of the infrared reflective film according to this embodiment is set to 50% or more.

Further, it is made difficult for (an adhesive layer 4 and) the substrate 1 to absorb near infrared radiation even if it is incident on (the adhesive layer 4 and) the substrate 1, so that near infrared radiation reaches the reflective layer 2. As a result, near infrared radiation is more likely to be reflected by the reflective layer 2. Accordingly, it is possible to block near infrared radiation entering the indoor passing through a translucent member such as a window glass by attaching the infrared reflective film according to this embodiment to the translucent member from the indoor side, which allows a thermal barrier effect to be expected during summer, in the same manner as in conventional infrared reflective films. For this purpose, the solar transmittance (see JIS A5759) when a ray is incident on the surface on the substrate 1 side (with reference to the reflective layer 2) of the infrared reflective film according to this embodiment is set to 60% or less.

Further, according to the infrared reflective film of this embodiment, good solvent resistance is imparted to the protective layer 3, as described above. That is, a polymer in the protective layer 3 is cross-linked, and thereby the solvent resistance of the protective layer 3 is improved. This can prevent elution of the protective layer 3 even if a polymer-soluble solvent comes into contact with the protective layer 3, and therefore can prevent a reduction in abrasion resistance due to exposure of the infrared reflective layer.

Further, according to the infrared reflective film of this embodiment configured as above, the dynamic friction coefficient on the surface of the protective layer 3 is 0.001 to 0.45, as described above. Therefore, the surface of the protective layer 3 has good slip characteristics (slip properties), so that an excessive force (stress) is prevented from acting on the surface of the protective layer 3, and the protective layer 3 is less likely to be partially or entirely broken. Accordingly, it is possible to prevent the situation where the reflective layer 2 having a low abrasion resistance is exposed due to breakage of the protective layer 3, and the reflective layer 2 is damaged. Further, this makes it possible to prevent the situation from developing such that the infrared reflective properties are impaired, and the infrared reflective film cannot exert its functions sufficiently.

### EXAMPLES

The inventors produced infrared reflective films according to the present embodiments (examples), and further produced infrared reflective films for comparison (comparative examples).

The examples and comparative examples are each produced as follows. A polyethylene terephthalate film having a thickness of 50 μm (product name “DIAFOIL T602E50”, manufactured by Mitsubishi Plastics, Inc.) was used as a substrate 1. A reflective layer 2 was formed on one surface 1a of the substrate 1 by DC magnetron sputtering. Specifically, using DC magnetron sputtering, a metal oxide layer 2b made of indium tin oxide with a thickness of 35 nm was formed on the surface 1a of the substrate 1, a semi-transparent metal layer 2a made of Ag—Pd—Cu alloy with a thickness of 18 nm was formed thereon, and a metal oxide layer 2c made of indium tin oxide with a thickness of 35 nm was formed further thereon. Thus, the reflective layer 2 was formed. Then, a protective layer 3 was formed on the reflective layer 2 by coating. It should be noted that formation conditions of the protective layer 3 will be described in detail in the respective examples and comparative examples.

### Example 1

10 wt % of hydrogenated nitrile rubber (product name “Therban 5065”, manufactured by LANXESS [k: 33.3, l: 63, m: 3.7, R1 to R3: H]) and 90 wt % of methyl ethyl ketone (manufactured by Wako Pure Chemical Industries, Ltd.) were mixed, and the hydrogenated nitrile rubber was dissolved in the methyl ethyl ketone solvent under stirring at 80° C. for five hours. Thus, a solution was prepared. The solution was applied onto the reflective layer 2 using an applicator, which was dried at 80° C. for 10 minutes in an air circulating drying oven. Thus, the protective layer 3 having a thickness of 5 μm was formed. Thereafter, it was subjected to electron beam irradiation from the surface side of the protective layer 3 using an electron beam irradiation apparatus (product name “EC250/30/20 mA”, manufactured by IWASAKI ELECTRIC CO., LTD.). The electron beam irradiation was performed under the conditions of: a line speed of 3 m/min, an acceleration voltage of 150 kV, and an accumulated irradiation dose of 600 kGy. In this example, electron beam irradiation was performed three times at a one-time irradiation dose of 200 kGy. More specifically, electron beam irradiation was first performed at an irradiation dose of 200 kGy from the surface side of the protective layer 3 (first time), as described above. Thereafter, a polyester release liner (product name “DIAFOIL MRN38”, manufactured by Mitsubishi Plastics, Inc.) was laminated to the surface of the protective layer 3 as a release liner. Then, the polyester release liner was peeled off after one minute. Next, electron beam irradiation was performed at an irradiation dose of 200 kGy from the surface side of the protective layer 3 (second time). Thereafter, another polyester release liner was laminated to the surface of the protective layer 3. Then, the polyester release liner was peeled off after one minute. Likewise, electron beam irradiation was performed at an irradiation dose of 200 kGy from the surface side of the protective layer 3 (third time). Thereafter, still another polyester release liner was laminated to the surface of the protective layer 3. Then, the polyester release liner was peeled off after one minute. In this way, an infrared reflective film according to Example 1 was obtained.

### Example 2

Example 2 is the same as Example 1 except that hydrogenated nitrile rubber (HNBR: product name “Therban 5005”, manufactured by LANXESS [k: 33.3, l: 66.7, m: 0, R1 to R3: H]) was used as a material for the protective layer.

### Example 3

Example 3 is the same as Example 1 except that acrylonitrile butadiene rubber (NBR: product name “JSR N222L”, manufactured by JSR Corporation [k: 27.4, l: 36.3, m: 36.3, R1, R4, R5: H]) was used as a material for the protective layer.

### Example 4

An infrared reflective film was obtained in the same manner as in Example 1 except that 0.5% of “GRANDIC PC4100” (product name), manufactured by DIC Corporation was added as a leveling agent with respect to the solid content of hydrogenated nitrile rubber when preparing the solution, electron beam irradiation was performed one time, and a polyester release liner (product name “DIAFOIL MRE38”, manufactured by Mitsubishi Plastics, Inc.) was used as the release film.

### Example 5

An infrared reflective film was obtained in the same manner as in Example 4 except that electron beam irradiation was performed at an irradiation dose of 80 kGy.

### Comparative Example 1

An infrared reflective film was obtained in the same manner as in Example 1 except that a polyester release liner was not layered after each time of electron beam irradiation.

### Comparative Example 2

An infrared reflective film was obtained in the same manner as in Example 1 except that “DIAFOIL MRF38” (product name), manufactured by Mitsubishi Plastics, Inc., was used as a polyester release liner, instead of “DIAFOIL MRN38” (product name), manufactured by Mitsubishi Plastics, Inc.

<Evaluation>

For each of Examples 1 to 5, and Comparative Examples 1 and 2, the dynamic friction coefficient on the surface of the protective layer 3 of the infrared reflective film, the normal emissivity of the infrared reflective film, and the transferred amount of silicone were measured as follows. Table 1 shows the results. The dynamic friction coefficient, the normal emissivity, and the transferred amount of silicone were measured in the state where the polyester release liner laminated after the third electron beam irradiation (in the case of one-time electron beam irradiation, after the first irradiation) was peeled off.

For the measurement of the dynamic friction coefficient on the surface of the protective layer 3 in each of Examples 1 to 5 and Comparative Examples 1 and 2, a friction and wear tester (FPR-2100, manufactured by RHESCA Corporation) was used. The dynamic friction coefficient in Examples 1 to 5, and Comparative Examples 1 and 2 was measured under the conditions of: an applied load of 50 g, a rotational speed of 5 rpm, a radius of rotation of 5 mm, a measurement time of 60 s, and a sampling time of 500 ms. Samples used as Examples 1 to 5, and Comparative Examples 1 and 2 were produced by being attached to a glass (5 cm×4.5 cm×1.2 mm thick) via an adhesive. The dynamic friction coefficient was calculated from an average of sampling data. When the dynamic friction coefficient on the surface of the protective layer 3 was 0.001 to 0.45, the slip characteristics (slip properties) were evaluated as good.

The normal emissivity was determined, in accordance with JIS R 3106-2008 (test method for the transmittance, reflectance, emittance, and solar heat gain coefficient of sheet glasses), by measuring a specular reflectance of the infrared light at a wavelength of 5 micron to 25 micron using a Fourier transform infrared (FT-IR) spectroscopy equipped with angle variable reflection accessories (manufactured by Varian, Inc.).

The transferred amount of silicone was measured using a fluorescent X-ray (XRF) diffractometer (ZSX100e, manufactured by Rigaku Corporation). The XRF measurement conditions were as follows: X radiation source: Vertical Rh tube; Analysis area: 30 mmφ; Analysis element: Si; Dispersive crystal: RX4; and Output: 50 kV, 70 mA. A Si—Ka curve was obtained from the aforementioned measurement, the intensity of Si was determined from the obtained Si—Ka curve, and the amount of Si was obtained from the determined intensity. Then, the obtained amount of Si was expressed in terms of the mass of dimethyl siloxane. Thus, the transferred amount of silicone component was determined.

TABLE 1

| | | | | Transferred |
|---|---|---|---|---|
| | | | | amount of |
| | | Dynamic | | silicone |
| | Release | friction | Normal | component |
| | liner | coefficient | emissivity | [g/m²] |
| Example 1 | MRN38 | 0.015 | 0.11 | 0.0040 |
| Example 2 | MRN38 | 0.026 | 0.10 | 0.0026 |
| Example 3 | MRN38 | 0.030 | 0.14 | 0.0021 |
| Example 4 | MRE38 | 0.066 | 0.12 | 0.0014 |
| Example 5 | MRE38 | 0.086 | 0.12 | 0.0006 |
| Comparative | None | 0.54 | 0.11 | 0.0000 |
| Example 1 | | | | |
| Comparative | MRF38 | Unmeasurable | Unmeasurable | Unmeasurable |
| Example 2 | | | | |

As shown in Table 1, the results of Example 1 showed good values of both the dynamic friction coefficient and the normal emissivity in which the dynamic friction coefficient on the surface of the protective layer 3 of the infrared reflective film was 0.015 (within the range of 0.001 to 0.45), and the normal emissivity of the infrared reflective film was 0.11 (0.20 or less). Further, the transferred amount of silicone component was 0.0040 g/m².

Further, the results of Example 2 showed good values of both the dynamic friction coefficient and the normal emissivity in which the dynamic friction coefficient on the surface of the protective layer 3 of the infrared reflective film was 0.026 (within the range of 0.001 to 0.45), and the normal emissivity of the infrared reflective film was 0.10 (0.20 or less), even in the case where hydrogenated nitrile rubber (HNBR: product name “Therban 5005”, manufactured by LANXESS [k: 33.3, l: 66.7, m: 0, R1 to R3: H]) was used as a material for the protective layer 3. Further, the transferred amount of silicone component was 0.0026 g/m².

Further, the results of Example 3 showed good values of both the dynamic friction coefficient and the normal emissivity in which the dynamic friction coefficient on the surface of the protective layer 3 of the infrared reflective film was 0.030 (within the range of 0.001 to 0.45), and the normal emissivity of the infrared reflective film was 0.14 (0.20 or less), even in the case where acrylonitrile butadiene rubber (NBR: product name “JSR N222L”, manufactured by JSR Corporation [k: 27.4, l: 36.3, m: 36.3, R1, R4, and R5: H]) was used as a material for the protective layer 3. Further, the transferred amount of silicone component was 0.0021 g/m².

Further, the results of Example 4 showed good values of both the dynamic friction coefficient and the normal emissivity in which the dynamic friction coefficient on the surface of the protective layer 3 of the infrared reflective film was 0.066 (within the range of 0.001 to 0.45), and the normal emissivity of the infrared reflective film was 0.12 (0.20 or less), even in the case where 0.5% of “GRANDIC PC4100” (product name), manufactured by DIC Corporation was added as a leveling agent with respect to the solid content of hydrogenated nitrile rubber, electron beam irradiation was performed one time, and a polyester release liner (product name “DIAFOIL MRE38”, manufactured by Mitsubishi Plastics, Inc.) was used. Further, the transferred amount of silicone component was 0.0014 g/m².

The results of Example 5 showed good values of both the dynamic friction coefficient and the normal emissivity in which the dynamic friction coefficient on the surface of the protective layer 3 was 0.086 (within the range of 0.001 to 0.45), and the normal emissivity of the infrared reflective film was 0.12 (0.20 or less), even in the case where electron beam irradiation was performed one time at an irradiation dose of 80 kGy. Further, the transferred amount of silicone component was 0.0006 g/m².

Further, the results of Comparative Example 1 were not good. Although the normal emissivity was 0.11 (0.20 or less), the dynamic friction coefficient was 0.54, which was over the range of 0.001 to 0.45, in the case where a polyester release liner was not layered after each time of electron beam irradiation. In Comparative Example 1, no silicone component was transferred to the protective layer 3 (the transferred amount of silicone component was 0.0000 g/m²). It was confirmed from this that the transfer of silicone component contributes to imparting the slip properties.

In the results of Comparative Example 2, it was impossible to measure the dynamic friction coefficient on the surface of the protective layer 3, the normal emissivity, and the transferred amount of silicone component, because the substrate (release liner) is difficult to peel off due to bonding between a polymer contained in the protective layer 3 which was activated by the electron beam and components contained in the substrate (release liner), as described above, in the case where “DIAFOIL MRF38” (product name), manufactured by Mitsubishi Plastics, Inc., was used as a polyester release liner.

It should be noted that the infrared reflective film according to the present invention is not limited to the aforementioned embodiments, and various modifications can be made without departing from the gist of the present invention.

For example, in the aforementioned embodiments, a polymer composed of the repeating units A and C, or at least two repeating units of the repeating units A, B, and C are described. However, there is no limitation to this. Repeating units other than these repeating units also may be contained within a range in which properties necessary as a protective layer are not impaired. Examples of the other repeating units include styrene, alpha-methylstyrene, (meth)acrylic acid, methyl (meth)acrylate, ethyl (meth)acrylate, 2-hydroxyethyl (meth)acrylate, vinyl acetate, and (meth)acrylamide. The content of these units is preferably 10 wt % or less with respect to the whole polymer.

Further, in the aforementioned embodiments, the reflective layer 2 is formed by vapor deposition. However, there is no limitation to this.

Further, in the aforementioned embodiments, a polyester release liner is used as a release liner. However, there is no limitation to this.

Further, the infrared reflective film according to the aforementioned embodiments has both thermal barrier properties and heat insulating properties. However, there is no limitation to this. The infrared reflective film according to the present invention, of course, can be applied also to a conventional infrared reflective film having only thermal barrier properties.

### REFERENCE SIGNS LIST

1: Substrate
1a: One Surface
1b: Other Surface
2: Reflective Layer
2a: Semi-transparent Metal Layer
2b, 2c: Metal Oxide Layer
3: Protective Layer
4: Adhesive Layer

1. An infrared reflective film comprising
a reflective layer and a protective layer, which are sequentially layered on one surface of a substrate, wherein
the protective layer contains a polymer containing at least two repeating units of repeating units A, B, and C shown in Formula I below: 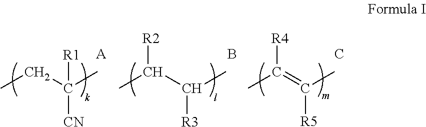
(R1: H or a methyl group, R2 to R5: H, or an alkyl group or an alkenyl group having 1 to 4 carbon atoms), and
a dynamic friction coefficient on a surface of the protective layer is 0.001 to 0.45.

2. The infrared reflective film according to claim 1, having a normal emissivity on a surface on the protective layer side of 0.20 or less.

3. The infrared reflective film according to claim 1, wherein
the protective layer further contains a silicone component disposed on the polymer so as to form a surface of the protective layer, and
an amount of the silicone component is 0.0001 to 1.0000 g/m².
